(19) United States
(12) Patent Application Publication
(10) Pub. No.: US 2009/0197040 A1
(43) Pub. Date: Aug. 6, 2009

(54) METHOD OF BORING GLASS SUBSTRATE AND GLASS SUBSTRATE FOR PLASMA DISPLAY MANUFACTURED BY THE METHOD

(75) Inventors: Shotaro Hanada, Tokyo (JP); Shengji Zheng, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, Chiyoda-ku (JP)

(21) Appl. No.: 12/422,720

(22) Filed: Apr. 13, 2009

Related U.S. Application Data
(63) Continuation of application No. PCT/JP07/69997, filed on Oct. 12, 2007.

(30) Foreign Application Priority Data
Oct. 13, 2006 (JP) 2006-280562

(51) Int. Cl. B32B 3/24; B23B 35/00

(52) U.S. Cl. 428/131; 408/1 R

(57) ABSTRACT

A first drill is pressed, in a rotating manner, against a lower surface of a glass substrate, to thus make a first hole of a predetermined depth. A second drill is pressed, in a rotating manner, against a position on an upper surface of the glass substrate opposing the first hole, to thus make a second hole, and the first hole and the second hole are brought into mutual communication with each other, to thus make a through hole in the glass substrate. A step on an internal periphery of the through hole formed as a result of the first hole and the second hole overlapping each other in a thicknesswise direction of the glass substrate is situated on the upper surface side than to the center of the glass substrate achieved in its thicknesswise direction.

### TECHNICAL FIELD

The present invention relates to a method for drilling a glass substrate and a glass substrate for a plasma display manufactured by the method; particularly, a glass substrate drilling method for making, in a rear-side glass substrate of two glass substrates to be assembled into a plasma display, a through hole for exhausting purpose, as well as to a glass substrate for a plasma display.

### BACKGROUND ART

A plasma display (Plasma Display Panel which will be hereinbelow abbreviated as “PDP”), which is a light-emitting direct view display, is made as a display of a slim large-screen TV by sealing two glass substrates, which consists of a front glass substrate and a rear glass substrate, with a sealant and filling the inside of the sealed glass substrates with a discharge gas. In the front glass substrate, a transparent dielectric substance and an MgO protective layer are formed over a display electrode for effecting an electric discharge. In the rear glass substrate, a fluorescent material is sequentially applied to stripe-shaped separators (ribs) for separating red, green, and blue fluorescent substances. A PDP of such a surface discharge reflection stripe structure is commercially available as a mass-produced color PDP panel.

Incidentally, the glass substrate for a PDP is manufactured by; for instance, a plate glass manufacturing method called a floating method. A lower surface (hereinafter called also as a “bottom surface”) of plate glass manufactured by the manufacturing method is a surface to act as a conveyance surface during the course of the glass substrate being manufactured by the floating method. When address electrodes of a PDP, and the like, are fabricated on the lower surface, the lower surface may be susceptible to a trouble because of a problem of surface roughness, a problem of flaws attributable to conveyance, and the like. Therefore, the address electrodes, and the like, are fabricated on an upper surface (hereinafter called a “top surface”) of the plate glass.

In relation to the glass substrate for a PDP, after having been subjected to predetermined processing to fabricate PDPs, a large plate glass substrate from which a plurality of PDPs can be fabricated is cut into final-PDP-size glass substrates. A rear plate of the PDP needs at least one exhaust hole; hence, a plurality of exhaust holes (through holes) are preliminarily made in one large plate glass substrate, which is to be processed into rear plates, before subjected to predetermined processing to manufacture PDPs.

An example process for manufacturing a rear glass substrate for a PDP will be described below. First, a sliver paste is provided on the upper surface (the top surface) of the glass substrate by means of screen printing, and the glass substrate is then sintered, to thus create stripe-shaped address electrodes and stripe-shaped separators so as to cover portions of the address electrodes. Specifically, a rib paste made by addition of a binder and a solvent to low-melting glass particles is iteratively applied at predetermined pitches by means of screen printing, thereby making a stripe-shaped separators. In a process for making a fluorescent substance layer, pastes respectively containing red, green, and blue fluorescent substances are sequentially applied to the separators by means of screen printing, and the thus-applied pastes are dried. Subsequently, the pastes are sintered in the air, to thus create a fluorescent substance layer.

Finally, black or gray flit glass, which is a sealant for sealing purpose, is applied to edges of the rear glass substrate. The glass substrate is subjected to de-bindering at a temperature of around 400° C., to thus make a sealed portion. Thus, the rear glass substrate for a PDP is manufactured.

JP-A-2000-158395 discloses an example method for drilling a glass substrate. According to the method, as shown in FIGS. 5A to 5C, a rotating diamond drill 1 is pressed against a bottom surface B of a glass substrate G, thereby making a lower hole 2. Further, as shown in FIGS. 5B to 5D, the rotating diamond drill 3 is pressed against a top surface T of the glass substrate G, to thus make an upper hole 4. As shown in FIG. 5E, the upper hole 4 is brought into mutual communication with the lower hole 2 by means of the diamond drill 3, to thus make (process) a through hole 5. The through hole 5 is processed by means of the two diamond drills 1, 2 with the glass substrate G sandwiched therebetween as mentioned above, whereby occurrence of a failure, such as chipping, which would arise in the surface of the glass substrate G, can be prevented.

Incidentally, the rear glass substrate is heated to hundreds degrees and forcefully cooled during the process for manufacturing a PDP; hence, thermal stress develops in the glass substrate. A related-art rear glass substrate G for a PDP encounters a problem of thermal cracking arising from thermal stress in a step 6, which serves as a starting point and which is formed on an interior periphery of the through hole (exhaust hole) 5 shown in FIGS. 5A to 5E. The step 6 originates from a mechanical error in (misalignment of) the two diamond drills 1, 3 and measures tens of microns.

### DISCLOSURE OF THE INVENTION

The present invention has been conceived in the circumstance and aims at providing a glass substrate drilling method and a glass substrate for a plasma display that enable prevention of occurrence of thermal cracking, which would otherwise arise in a step on a through hole made in a glass substrate.

The inventors of the present invention inferred a cause for thermal cracking attributable to the step on the through hole made in the glass substrate and verified the cause through tests. A word “make” employed herein implies a case where a glass substrate is processed.

An outline of inference is first described. As mentioned above, the rear glass substrate for a PDP is processed in the PDP manufacturing process with the bottom surface B facing down and the top surface T facing up. Accordingly, when heated, the rear glass substrate is heated while being placed on a plate-shaped element called a setter, or the like. Therefore, the bottom surface B undergoes a heat rise faster than does the top surface. The glass substrate G was heated to hundreds degrees (e.g., about 280 degrees) while the bottom surface B of the glass substrate G was placed on a heater (not shown) as shown in FIG. 6, so as to induce the same phenomenon, margins of the substrate exhibited tendency toward warpage under the circumstance where the temperature of the center of the glass substrate was high and where the temperatures of the margins of the same were low, and the center of the glass substrate G assumed a downwardly-protruding shape. When such deformation appeared at the location of the through hole, contraction stress CF acted on the top surface T of the glass substrate G corresponding to the location of the through hole, and tensile stress TF acted on the bottom surface B of the glass substrate G where the through hole was located.

In general, the glass substrate is vulnerable to tensile stress than to contraction stress. Hence, when the glass substrate G is heated as mentioned above, the glass substrate G becomes prone to cracking when flaws are present in the bottom surface.

In the meantime, the through hole 5 has the step 6 formed on the interior periphery of the through hole as described in connection with FIG. 7, and such a step is susceptible to small cracks or flaws. FIG. 8 shows a distribution of stress in the through hole 5 of the glass substrate G achieved in its thicknesswise direction. As shown in FIGS. 7 and 8, when the position of the step 6 is on the top surface T side with reference to the center S achieved in the thicknesswise direction, plane stress exerted on the step 6 made on the through hole 5 of the glass substrate G turns into contraction stress CF. When the step 6 is located on the bottom surface B side than to the center S in the thicknesswise direction, plane stress exerted on the step 6 formed on the through hole 5 of the glass substrate G turns into tensile stress TF. An inference was made to a case where, when the step 6 is situated on the bottom surface B side with reference to the center S achieved in the thicknesswise direction, tensile stress is exerted on small cracks, flaws, or the like, developed in the step, whereupon cracks (hereinafter called also “thermal cracks”) arise in the glass substrate G from small cracks or flaws as starting points. As mentioned above, glass generally exhibits higher strength to compression stress than to tensile stress. Accordingly, an inference was made to a case where, in relation to the glass substrate G that is heated in such a way that the bottom surface B becomes hotter than does the top surface T as in the case of the rear glass substrate for a PDP, when the glass substrate has the through hole 5, the step 6 formed on the through hole 5 is situated at the top surface T side with reference to the center S of the glass substrate G achieved in its thicknesswise direction, whereby occurrence of thermal cracking in the step 6 of the through hole 5 can be avoided.

On the basis of the inferences, the glass substrate G was processed such that the step 6 was situated on the top surface side T; namely, the top surface T side with reference to the center S of the glass substrate G achieved in its widthwise direction, and the other glass substrate G was processed such that the step was situated on the bottom surface B side. The glass substrates G were heated (to about 280 degrees: namely, in such a way that a temperature difference between the top surface T and the bottom surface B came to about 170 degrees) while being placed on the heater and while bottom surfaces B of the glass substrates were placed on the heater, and occurrence of thermal cracking was checked.

As a consequence, in relation to the glass substrates G in which the step 6 is situated on the bottom surface B side with reference to the center S of the glass substrate G in its thicknesswise direction, thermal cracking attributable to the step 6 of the through hole 5 arose in six glass substrates out of 20 glass substrates at about 10 to 20 seconds. In particular, cracking noticeably arose in the through holes 5 formed in the vicinities of the longitudinal center of the glass substrates G. A presumable reason for this is that great tensile stress exerted on the through hole formed in the longitudinal center than on the through hole 5 formed in a longitudinal end of the glass substrate G. In contrast, even when the glass substrates G whose steps 6 are situated on the top surface T side with reference to the center S achieved in the thicknesswise direction were heated for about 10 to 20 seconds, thermal cracking attributable to the step of the through hole 5 arose in none of 60 glass substrates G.

On the basis of the above results of inference and verification, in order to achieve the objective, the present invention provides a method for drilling a glass substrate, comprising pressing a first drill, in a rotating manner, against a lower surface of a glass substrate, thereby making a first hole of a predetermined depth; and pressing a second drill, in a rotating manner, against a position on an upper surface of the glass substrate opposing the first hole, to thus cut through the second hole, whereby the first hole and the second hole are brought into mutual communication with each other and at least one through hole made in the glass substrate. A step made on an interior periphery of the through hole formed as a result of the first hole and the second hole overlapping each other in a thicknesswise direction of the glass substrate is situated on the upper surface side than to a center of the glass substrate achieved in its thicknesswise direction.

The glass substrate is preferably a glass substrate subjected to heat treatment after having been drilled.

Preferably, a glass substrate for use as a rear plate of a plasma display manufactured by a floating method is used as the glass substrate; the lower surface serves as a conveyance surface under the floating method, and the upper surface is preferably a surface opposite to the conveyance surface and serves as a surface on which electrodes of the plasma display are to be fabricated.

According to the present invention, there is provided a glass substrate for use as a plasma display manufactured by the foregoing method for drilling a glass substrate. According to the present invention, there is provided a method for drilling a glass substrate, comprising pressing a first drill, in a rotating manner, against a lower surface of a glass substrate, thereby making a first hole of a predetermined depth; and pressing a second drill, in a rotating manner, against a position on an upper surface of the glass substrate essentially identical with the first hole in a planar direction, to thus cut through a second hole and thereby bring the first hole and the second hole in mutual communication with each other and making at least one through hole in the glass substrate, wherein the through hole is machined in such a way that a step made on an interior periphery of the through hole formed as a result of the first hole and the second hole overlapping each other is situated on the upper surface side than to a center of the glass substrate achieved in its thicknesswise direction. Hence, occurrence of thermal cracking, which would otherwise be caused by the step on the through hole drilled in the glass substrate, can be prevented.

Moreover, the through hole is machined under the drilling method. Hence, a glass substrate for a rear plate of a plasma display that prevents occurrence of thermal cracking, which would otherwise be caused by a step of the through hole drilling in the glass substrate, can be provided.

### BRIEF DESCRIPTION OF THE DRAWINGS

FIG. 1 is a front view showing the configuration of a glass substrate drilling apparatus.

FIGS. 2A to 2E are descriptive views showing procedures of a drilling method of a first embodiment of the present invention.

FIGS. 3A to 3F are descriptive views showing procedures of a drilling method of a second embodiment of the present invention.

FIG. 4 is a plan view showing an example large glass substrate for PDP rear glass substrates before being subjected to predetermined processing for making PDPs.

FIGS. 5A to 5E are descriptive views showing procedures of a related-art drilling method.

FIG. 6 is a descriptive view of thermal stress developed in the glass substrate.

FIG. 7 is a descriptive view showing the direction of thermal stress developing in a bottom surface of the glass substrate.

FIG. 8 is a descriptive view showing the distribution of thermal stress developing in a through hole of the glass substrate.

### BEST MODE FOR IMPLEMENTING THE INVENTION

An embodiment of the present invention will be described hereinbelow by reference to the accompanying drawings.

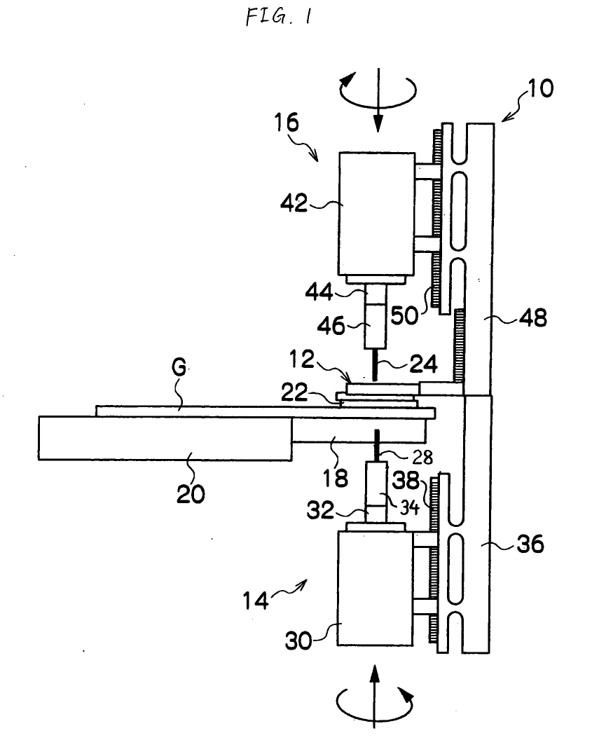

FIG. 1 is a front view showing the configuration of an apparatus 10 that drills a glass substrate G and that implements a method for drilling a glass substrate of a first embodiment of the present invention. The drilling apparatus 10 is made up of a clamping unit 12; a lower drilling unit 14, and an upper drilling unit 16.

A glass substrate G to be drilled by the drilling apparatus 10 is a glass substrate G that is used for a plasma display; that is manufactured by a floating technique; and that has a thickness of 1.8 to 2.8 mm. A bottom surface B of the glass substrate G is a conveyance surface used when the glass substrate is manufactured by the floating technique, and address electrodes of the plasma display are fabricated on a top surface T of the glass substrate G.

The clamping unit 12 of the drilling apparatus 10 is a device for clamping the glass substrate G between the clamping device and a clamp table 18, and presses the top surface T of the glass substrate G placed on a table 20 of a main body of the drilling apparatus 10 by means of a clamping plate 22, to thus clamp the glass substrate. The clamp plate 22 is made into a ring shape, and a diamond drill (a second drill) 24 of the upper drilling unit 16 to be described later is inserted into an inner radius portion of the clamp plate and drills an upper hole (a second hole) in the glass substrate G.

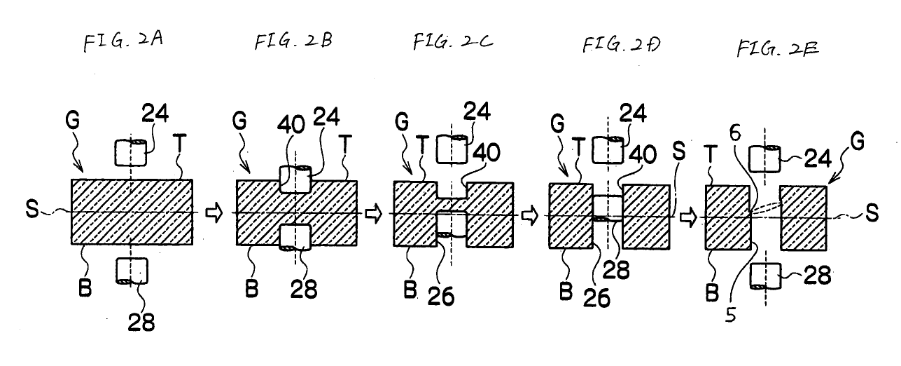

As shown in FIGS. 2A to 2D, the lower drilling unit 14 is a device that drills a lower hole (a first hole) 26 of a predetermined depth into the bottom surface B of the glass substrate G, and presses a rotating diamond drill (a first drill) 28 against the lower surface of the glass substrate G, to thus drill a lower hole 26 of a predetermined depth. As shown in FIG. 1, the diamond drill 28 is positioned substantially, perpendicularly to the clamp table 18 and attached to a horn 32 of a spindle 30 by way of a holder 34. The spindle 30 is attached to a spindle attachment section 36 in a lifting manner by way of a translation guide 38, and is vertically moved essentially at right angles to the glass substrate G by an unillustrated feed screw unit. The lower drilling unit 14 presses the diamond drill 28 against the bottom surface B of the glass substrate G and imparts rotation and feeding to the bottom surface, thereby drilling the lower hole 26. Although unillustrated, an insert hole is made in the clamp table 18, and the diamond drill 28 is brought into contact with the bottom surface B of the glass substrate G by way of the insert hole.

As shown in FIGS. 2B and 2C, the upper drilling unit 16 is a device that drills an upper hole 40 in the top surface T of the glass substrate G and presses the rotating diamond drill 24 against the top surface T of the glass substrate G, thereby drilling the upper hole 40.

The diamond drill 24 shown in FIG. 1 is provided opposite the diamond drill 28; positioned essentially, perpendicularly to the clamp table 18; and is attached to the horn 44 of the spindle 42 by way of a holder 46. The spindle 42 is attached to a spindle mount section 48 in a lifting manner by way of a translation guide 50 and vertically moved substantially perpendicularly to the glass substrate G by means of an unillustrated feed screw. The upper drilling unit 16 presses the diamond drill 24 against the top surface T of the glass substrate G and imparts rotation and feeding to the top surface, thereby drilling the upper hole 40.

A drilling method of the present embodiment using the drilling apparatus 10 will now be described by reference to FIGS. 2A to 2E.

First, as shown in FIG. 2A, the diamond drill 24 is positioned on the top surface T side with the glass substrate G sandwiched therebetween, and the diamond drill 28 is positioned on the bottom surface B side opposing the diamond drill 24. A mechanical error (misalignment) between the diamond drill 24 and the diamond drill 28 achieved along the direction of the plane is tens of microns.

As shown in FIG. 2B, the diamond drill 24 is lowered, to thus start drilling the upper hole 40. Further, the diamond drill 28 is elevated, to thus start drilling the lower hole 26.

As shown in FIG. 2C, drilling of the upper hole 40 performed by the diamond drill 24 is stopped at a point in time when the diamond drill 24 has drilled the upper hole 40 to a predetermined position that is higher than a center S in the thicknesswise direction, and the diamond drill 24 is moved upward from the upper hole 40 in a receding fashion. In the meantime, drilling of the lower hole 26 performed by the diamond drill 28 is continuously carried out, and the diamond drill 28 cuts through the lower hole 26 and the upper hole 40 as shown in FIG. 2D, thereby drilling the through hole 5 that is an exhaust hole, as shown in FIG. 2E.

At this time, a position where drilling of the lower hole 26 is to be stopped; namely, the depth of the lower hole, is determined in such a way that the step 6 formed on the interior periphery of the through hole 5 as a result of the lower hole 26 and the upper hole 40 overlapping each other comes to the top surface T side rather than to the center S of the glass substrate G achieved in its thicknesswise direction. Consequently, the step 6 formed on the internal periphery of the through hole 5 as a result of the lower hole 26 and the upper hole 40 overlapping each other is situated on the top surface T side than to the center S of the glass substrate G achieved in its thicknesswise direction. Hence, occurrence of thermal cracking, which would otherwise be caused by the step 6 formed on the internal periphery of the through hole 5 that is the exhaust hole made in the glass substrate G, can be prevented. The reason and ground for this is as mentioned previously.

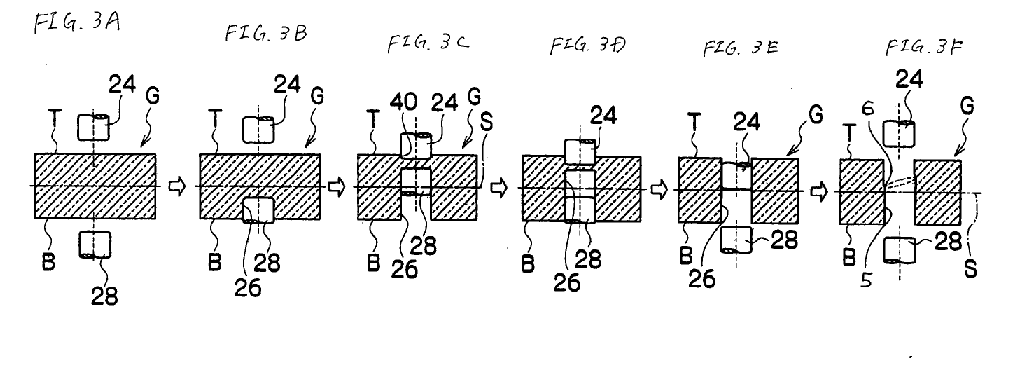

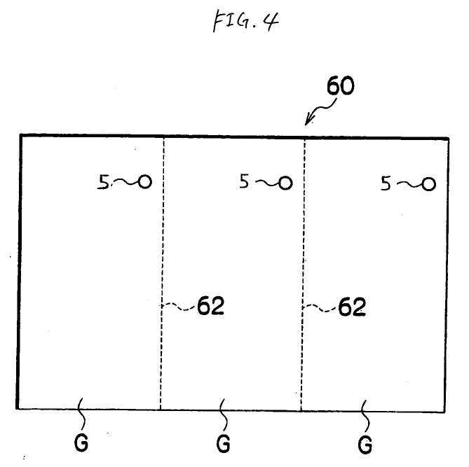

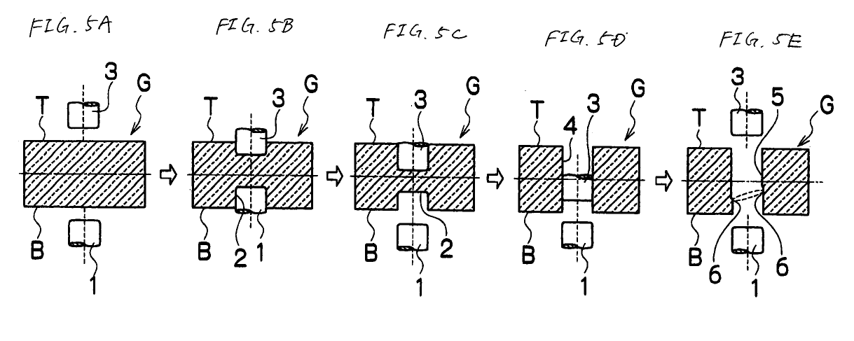

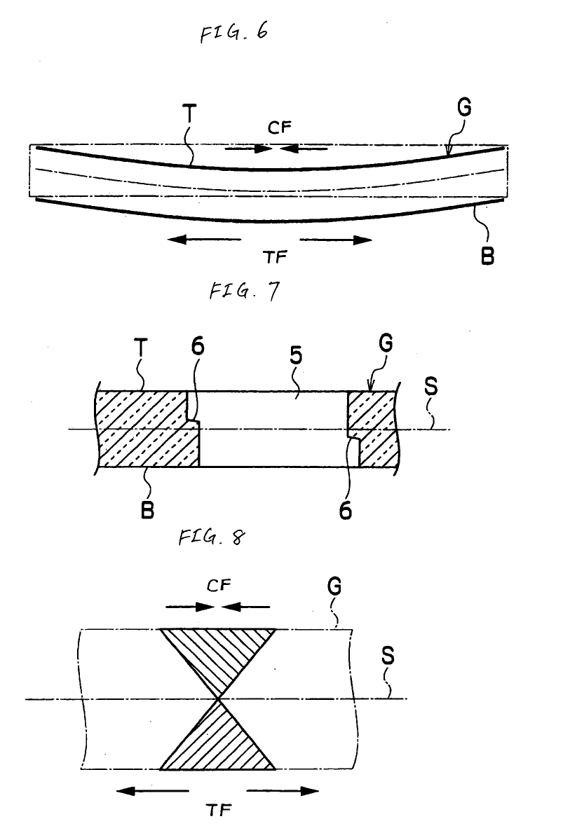

Procedures of a drilling method of a second embodiment of the present invention using the drilling apparatus 10 will now be described by reference to FIGS. 3A to 3F.

First, as shown in FIG. 3A, in the present embodiment, the diamond drill 24 is situated on the top surface T side with the glass substrate G sandwiched therebetween, and the diamond drill 28 is situated on the bottom surface B side opposing the diamond drill 24.

As shown in FIG. 3B, the diamond drill 28 is elevated, to thus start drilling the lower hole 26.

As shown in FIG. 3C, drilling of the lower hole 26 performed by the diamond drill 28 is halted at a point in time when the diamond drill 28 cuts through the lower hole 26 up to a predetermined position that is higher than the center S of the diamond drill 28 achieved in its thicknesswise direction.

In the meantime, the diamond drill 24 is lowered, to thus machine the upper hole 40, and the diamond drill 28 is moved downwardly from the lower hole 26 in a receding manner as shown in FIG. 3D. On the other hand, machining of the upper hole 40 performed by the diamond drill 24 is continuously performed, and the diamond drill 24 cuts through the upper hole 40 and the lower hole 26, as shown in FIG. 3E, whereupon the through hole 5 that is an exhaust hole is made as shown in FIG. 3F.

Even in the present embodiment, the position where drilling of the lower hole 26 is to be stopped; namely, the depth of the lower hole, is determined in such a way that the step 6 formed on the interior periphery of the through hole 5, which is an exhaust hole, as a result of the lower hole 26 and the upper hole 40 overlapping each other comes to the top surface T side rather than to the center S of the glass substrate G achieved in its thicknesswise direction, as in the first embodiment shown in FIGS. 2A to 2E. Consequently, the step 6 formed on the through hole 5 as a result of the lower hole 26 and the upper hole 40 overlapping each other is situated on the top surface T side than to the center S of the glass substrate G achieved in its thicknesswise direction. Hence, occurrence of thermal cracking, which would otherwise be caused by the step 6 formed on the internal periphery of the through hole 5 that is the exhaust hole made in the glass substrate G, can be prevented.

The essential requirement of the step 6 is that it should be situated on the top surface T side than to the center S of the glass substrate G achieved in its thicknesswise direction. For instance, in the case of the glass substrate G having a thickness of 1.8 mm, it is preferable to set the amount of descent of the upper diamond drill 24 from the top surface T of the glass substrate G to a range from 0.1 to less than 0.9 mm, in consideration of a degree of mechanical accuracy of the drilling apparatus 10. Moreover, a preferred shape of a drill used for the drilling apparatus 19 is a truncated conical shape. When such a drill is used, it is preferable to set the amount of descent of the upper diamond drill 24 from the top surface T of the glass substrate G to a range from 0.3 to less than 0.9 mm, in consideration of the amount of a required overlap between the drills. In a case where a through hole is drilled in the glass substrate, when a hole is made by the drill from a direction of only one surface of the glass substrate G, the glass substrate G sometimes becomes fractured immediately before the drill cuts through the substrate. In consideration of a fracture in glass, it is preferable to set the amount of ascent of the lower diamond drill 28 from the bottom surface B of the glass substrate G to a range from 0.9 to 1.7 mm; more preferably, a range from 1.5 mm to 1.7 mm; and more preferably, a range from 1.1 mm to 1.7 mm in consideration of the shape of the drill as in the case of the upper diamond drill 24.

FIG. 4 shows an example large glass substrate 60 for PDP rear glass substrates before being subjected to predetermined processing for making PDPs. The through hole 5 that is to serve as an exhaust hole (with a diameter of; for instance, 2 mm) is drilled at three predetermined locations on the large glass substrate 60. Subsequently, a top surface T of the large glass substrate 60 is subjected to predetermined processing to prepare PDP rear glass substrates G. The large glass substrate 60 is then sliced along two cut lines 62, 62 indicated by broken lines shown in FIG. 4, whereby three PDP rear glass substrates G are produced.

### Example

A total of 60 samples were prepared by opening the through hole 5 with a diameter of 2 mm at positions spaced 11.5 mm away from respective two orthogonal end faces of an essentially-rectangular PDP glass substrate G measuring 150×150 mm and having a thickness of 1.8 mm, in which the step 6 to appear on the through hole 5 was made at a position spaced 1.7 mm from the bottom surface B of the glass substrate G. In seven samples of them, the steps 6 were made at intervals of 0.1 mm downward from a position 1.7 mm away from the bottom surface up to a position of 1.0 mm. In four of the samples, the step 6 was made at a position 0.9 mm away from the bottom surface B of the glass substrate G. In relation to the samples, the glass substrates G were heated for ten minutes (at about 280 degrees: where a temperature difference of about 170 degrees between the top surface and the bottom surface is achieved) while the bottom surfaces B were placed on the heater held at a high temperature (about 280 degrees), and occurrence of thermal cracking attributable to the step 6 on the through hole 5 was ascertained. As a consequence, thermal cracking attributable to the step 6 on the through hole 5 did not occur in the 60 samples.

In contrast, a total of 20 samples were prepared by opening the through hole 5 with a diameter of 2 mm at positions spaced 11.5 mm away from respective two orthogonal end faces of the PDP glass substrate G measuring 150 mm×150 mm and having a thickness of 1.8 mm. In seven samples of them, the step 6 to appear on the through hole 5 is situated at each of positions 0.5 mm and 0.6 mm away from the bottom surface B of the glass substrate G. In six of the samples, the step 6 is situated at a position 0.56 mm away from the bottom surface B of the glass substrate G. Tests analogous to those mentioned above were conducted. Thermal cracking attributable to the step 6 of the through hole 5 occurred in the six glass substrates G of the twenty glass substrates G at about 0 to 20 seconds after heating.

Therefore, it was shown even by these tests that thermal cracking attributable to the step 6 can be prevented by placing the step 6 on the top surface T side than at the center S of the glass substrate G in its thicknesswise direction.

Additionally, the same tests were conducted through use of samples in which the step 6 was made at a position 0.8 mm away from the bottom surface B of the glass substrate G, and the tests showed that a rate of occurrence of thermal cracking is small. However, it may be the case where the position undergoes small stress stemming from thermal strain but is susceptible to compression stress or tensile stress. Since stable thermal strength cannot be assured, it is preferable that the step 6 be placed at the upper surface T side than to the center S of the glass substrate G achieved in its thicknesswise direction where the step undergoes compression stress.

In the above embodiment, the method for drilling a plasma display has been described. However, the present invention can also be applied to a method for drilling a glass substrate, such as an FED (Field Emission Display) and an SED (Surface-Conduction Electron-emitter Display).

1. A method for drilling a glass substrate, comprising:
pressing a first drill, in a rotating manner, against a lower surface of a glass substrate, thereby making a first hole of a predetermined depth; and
pressing a second drill, in a rotating manner, against a position on an upper surface of the glass substrate opposing the first hole, to thus make a second hole and thereby bring the first hole and the second hole in mutual communication with each other and making a through hole in the glass substrate, wherein
a step made on an interior periphery of the through hole formed as a result of the first hole and the second hole overlapping each other in a thicknesswise direction of the glass substrate is situated on the upper surface side than to a center of the glass substrate achieved in its thicknesswise direction.

2. The method for drilling a glass substrate according to claim 1, wherein
the glass substrate is a glass substrate subjected to heat treatment after having been drilled.

3. The method for drilling a glass substrate according to claim 1, wherein
a glass substrate for use as a rear plate of a plasma display manufactured by a floating method is used as the glass substrate; the lower surface serves as a conveyance surface under the floating method; and the upper surface is a surface opposite to the conveyance surface and serves as a surface on which electrodes of the plasma display are to be fabricated.

4. A glass substrate for use as a rear plate of a plasma display manufactured by the method for drilling a glass substrate according to claim 1.
